(19) United States
(12) Patent Application Publication
(10) Pub. No.: US 2011/0289227 A1
(43) Pub. Date: Nov. 24, 2011

(54) METHOD OF MULTI-TERMINAL CONNECTION TRAVERSING NAT WITHOUT THIRD PARTY INTERFACING

(76) Inventor: Bruce HSU, Taipei (TW)

(21) Appl. No.: 12/782,109

(22) Filed: May 18, 2010

(51) Int. Cl. G06F 15/16

(52) U.S. Cl. 709/228

(57) ABSTRACT

A method of multi-terminal connection traversing a network address translation (NAT) without third party interfacing is provided, which is applicable to existing network communication protocols. The method is mainly used to realize connection of a user end having a NAT or a firewall with a third party, and enable the user end to form direct network interconnection with other user ends through a multi-terminal network connection system without additionally opening a network connection port for the NAT or firewall. Moreover, the method enables a user of the user end to additionally load Internet application programs, such as Voice over Internet Protocol (VoIP) and video conference, on the multi-terminal network connection system based on demands of the user or for work. In addition, the user end may realize direct network interconnection through a checking mechanism of the NAT Internet protocol, so as to avoid information security vulnerability caused by exceptional opening of the network connection port for network connection, and the network connection is implemented without third party or proxy server interfacing. Therefore, the security of network connection between user ends is enhanced and the occurrence of information vulnerability is reduced.

### BACKGROUND OF THE INVENTION

1. Field of Invention

The present invention relates to a method of multi-terminal network connection, which is mainly applied for network connection between user ends, and more particularly to a method capable of being implemented in network communication protocols, so that a user end does not need to open a network connection port exceptionally for network connection and can further load network application programs on a multi-terminal network connection system.

2. Related Art

With the popularization of broadband networks, the conventional client-server network structure is gradually replaced by peer-to-peer (P2P) network communication architecture. A firewall is usually set at a user end to prevent files from being stolen by malicious users through the internet, or a network address translation (NAT) is established so that multiple users at the user end can use the same Internet Protocol (IP) address to realize network connection to the outside. However, in order to realize network connection with other users, the settings of the firewall or NAT need to be changed, so as to enable connection to the outside through a specific network connection port. Thus, information security vulnerability occurs on the firewall, and many malicious users may invade a computer to steal data through the vulnerability. To solve this problem, many technologies of traversing a firewall or a NAT, such as Universal Plug and Play (UPnP), Traversal Using Relay NAT (TURN), and Simple Traversal of User Datagram Protocol through Network Address Translation (NATs) (STUN), are proposed. Taking the TURN technology as an example, FIG. 1 is a schematic view of implementation of the TURN technology. As shown in FIG. 1, a user end 10 mainly realizes network connection with another user end 12 through a proxy server 11, and a firewall 101 (or a NAT) is established at the user end 10. Referring to FIG. 2 in combination, FIG. 2 is a flow chart of implementation of the TURN technology. When the user end 10 intends to establish network connection with the other user end 12, the network connection process is as follows.

In Step 21 (Initiate an intermediary request), when the user end 10 intends to establish network connection with the other user end 12, the user end 10 sends an intermediary proxy request to the proxy server 11.

In Step 22 (Assign a public port), after the proxy server 11 receives a signal, an interfacing public port among public ports of the proxy server 11 is assigned for use to the user end 10.

In Step 23 (Connect with the proxy server), the proxy server 11 returns a related network connection message to the user end 10, and the user end 10 is enabled to transfer information through the proxy server.

In Step 24 (Connect with a third party), after the connection between the user end 10 and the proxy server 11 is established, network connection between the user end 10 and a third party such as the other user end 12 is realized through the proxy server 11.

In the TURN technology, the proxy server 11 is adopted to perform intermediary processing between the user ends (10, 12). Although this technology can traverse the firewall, the P2P feature is lost and a client-server mode is obtained. Moreover, the proxy server bears all the communication loads. Further, the STUN technology is implemented in symmetric NAT architecture. Although network connection is established between two parties through temporary interfacing of the proxy server, limited by the symmetric NAT architecture, the network connection port is unable to be reused. Besides, in order to solve the problem of traversing the firewall and the NAT, in many enterprises, in addition to the use of the traverse technology, other network connection technologies are used in combination and a related hardware device such as virtual private network (VPN) is established. However, if the offices of the enterprise scatter in different places, the establishment of the VPN may cause a great amount of cost.

### SUMMARY OF THE INVENTION

In order to solve the above problems, the present invention is mainly directed to a method of multi-terminal network connection, in which a network connection port does not need to be opened exceptionally, data does not need to be interfaced through a proxy server, and network application programs can be loaded.

In order to achieve the above objective, in the present invention, a multi-terminal network connection system is established at a user end, and a network signal connection is established between two user ends through a proxy server. When the connection is established, the proxy server does not need to perform intermediary processing therebetween. Therefore, during network connection between the user end and the third party, related network connection can be realized in a status with firewall protection or established with a NAT. Moreover, based on demands and preferences, the user may load network application programs in the multi-terminal network connection system according to the present invention.

The above description of the content of the present invention and the following illustration of the embodiments are intended to demonstrate and explain the spirit and principle of the present invention and to provide further explanations of the claims of the present invention.

### BRIEF DESCRIPTION OF THE DRAWINGS

The present invention will become more fully understood from the detailed description given herein below for illustration only, and thus are not limitative of the present invention, and wherein:

FIG. 1 is a schematic view of implementation of a TURN technology;

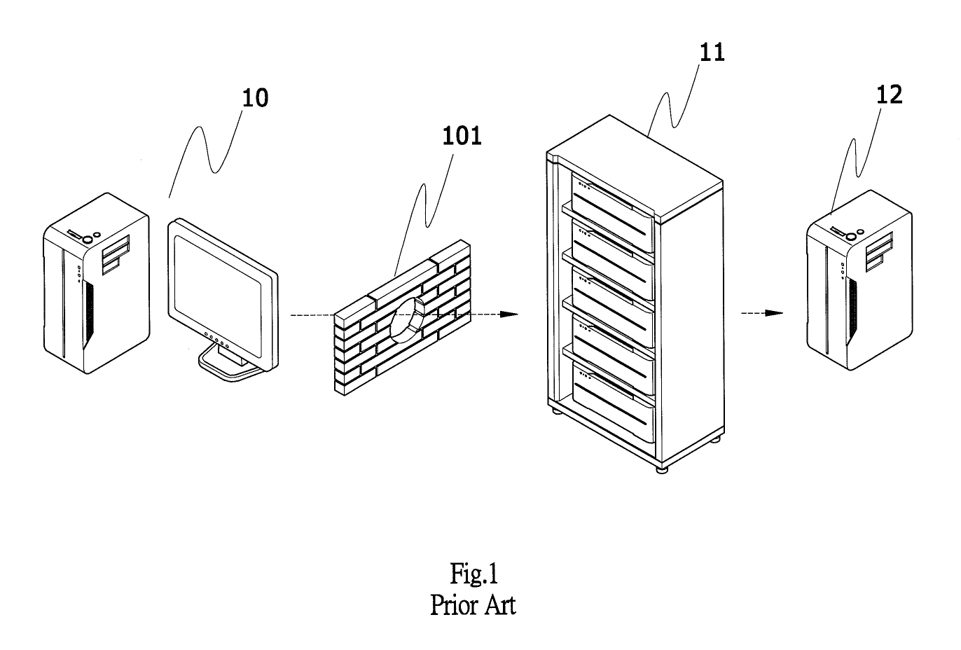

FIG. 2 is a flow chart of implementation of the TURN technology;

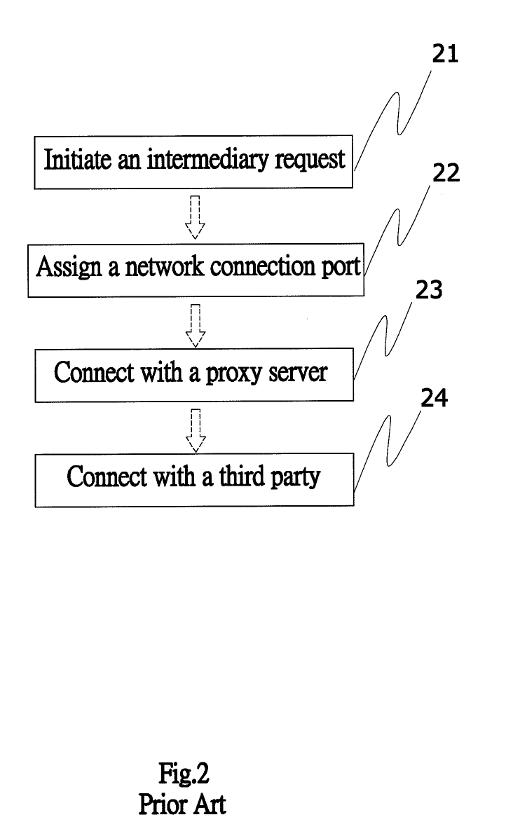

FIG. 3 is a schematic view of implementation architecture according to the present invention;

FIG. 4 is a flow chart of implementation according to the present invention;

FIG. 5 is a schematic view (1) of implementation according to the present invention;

FIG. 6 is a schematic view (2) of implementation according to the present invention;

FIG. 7 is a flow chart of implementation of a checking mechanism;

FIG. 8 shows a preferred embodiment of the present invention; and

FIG. 9 is a diagram of an interface of a connection system according to a preferred embodiment of the present invention.

### DETAILED DESCRIPTION OF THE INVENTION

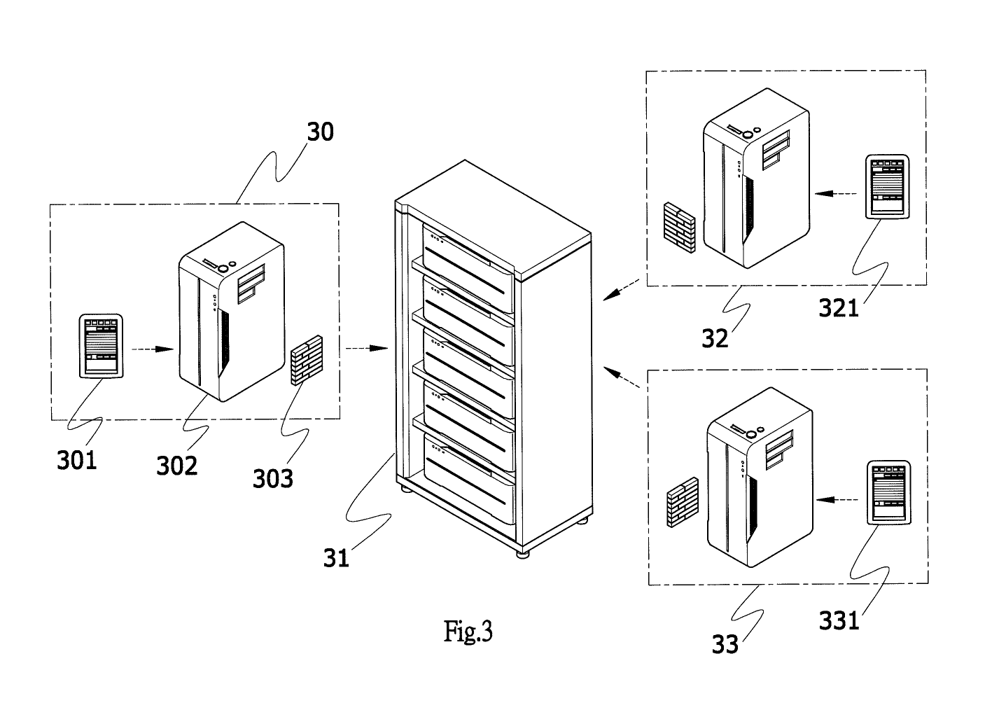

FIG. 3 is a schematic view of implementation architecture according to the present invention. In FIG. 3, each user end 30 establishes a multi-terminal network connection system 301 in an information device 302, and the multi-terminal network connection system 301 can be connected to a proxy server 31 in an informational mode in a status that a firewall 303 is activated for protection (or a NAT is provided).

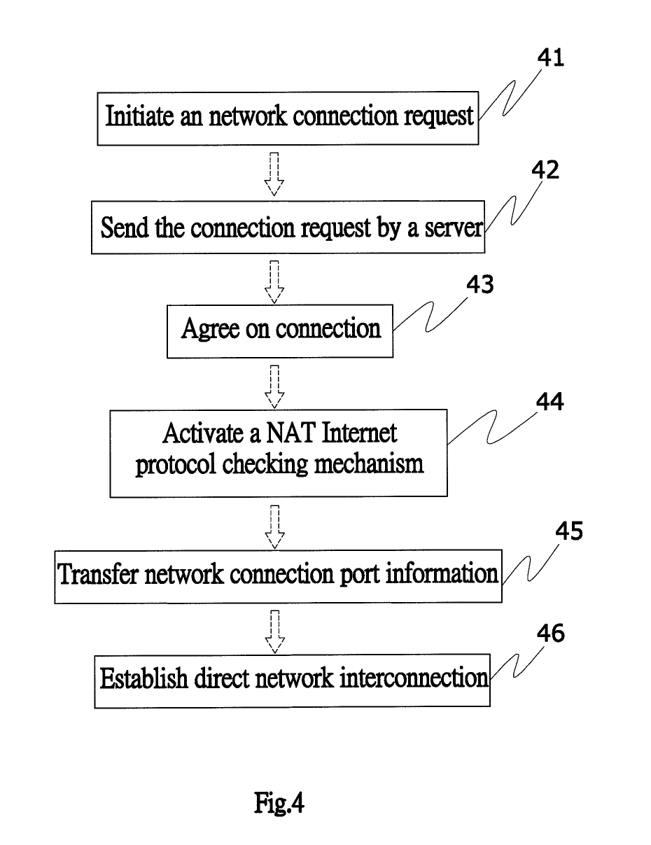

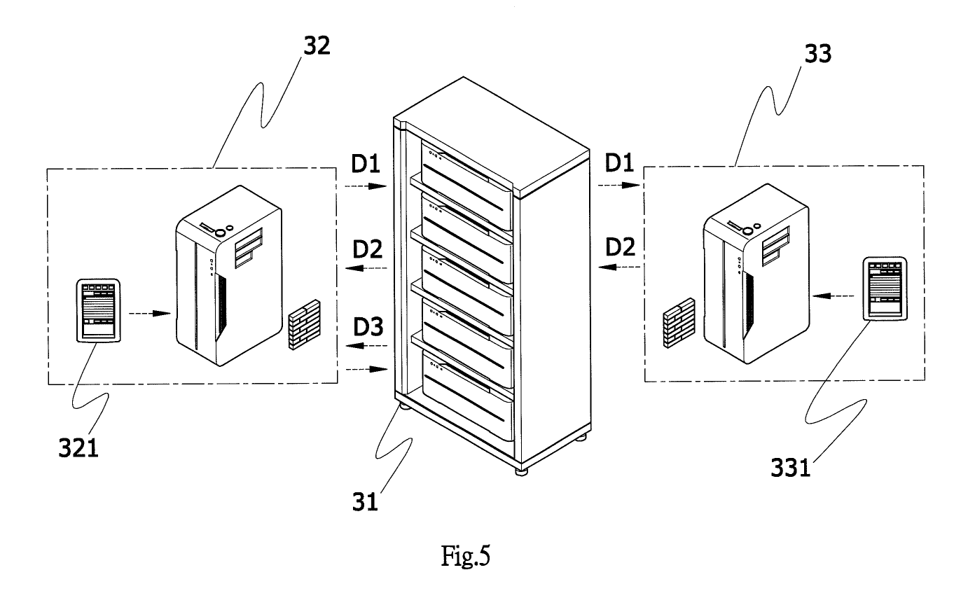

FIG. 4 is a flow chart of implementation according to the present invention. Meanwhile, referring to FIGS. 3 and 5, FIG. 5 is a schematic view (1) of implementation according to the present invention. When a calling end 32 intends to establish network connection with a third party, the network connection is established through a multi-terminal network connection system 321. The implementation process is as follows.

In Step 41, a network connection request is initiated. When the calling end 32 intends to establish network connection with a called end 33, the calling end 32 sends a network connection request to the proxy server 31 through the multi-terminal network connection system 321.

In Step 42, the proxy server sends the connection request. The proxy server 31 forwards the connection request sent by the calling end 32 to the called end 33.

In Step 43, connection is agreed on. Within a specific period of time (for example, 9 seconds) after the proxy server 31 sends the network connection request based on the demand of the calling end 32, the called end 33 responds and agrees on the connection. Subsequently, the proxy server 31 returns a related message to the calling end 32.

In Step 44, a NAT Internet protocol checking mechanism is activated. After the two parties agree on the connection, the multi-terminal network connection systems (321, 331) of the calling end 32 and the called end 33 start to check encoding principles of network connection ports for the firewall 303 (or the NAT) of the information devices of the two user ends, and generate expected network communication port data (D1, D2), respectively.

In Step 45, network connection port information is transferred. The expected network connection port data (D1, D2) of the two parties are transferred to the calling end 32 and the called end 33 through the proxy server 31, respectively. For example, the expected network connection port data D2 of the called end 33 is transferred to the calling end 32, and the expected network connection port data D1 of the calling end 32 is transferred to the called end 33.

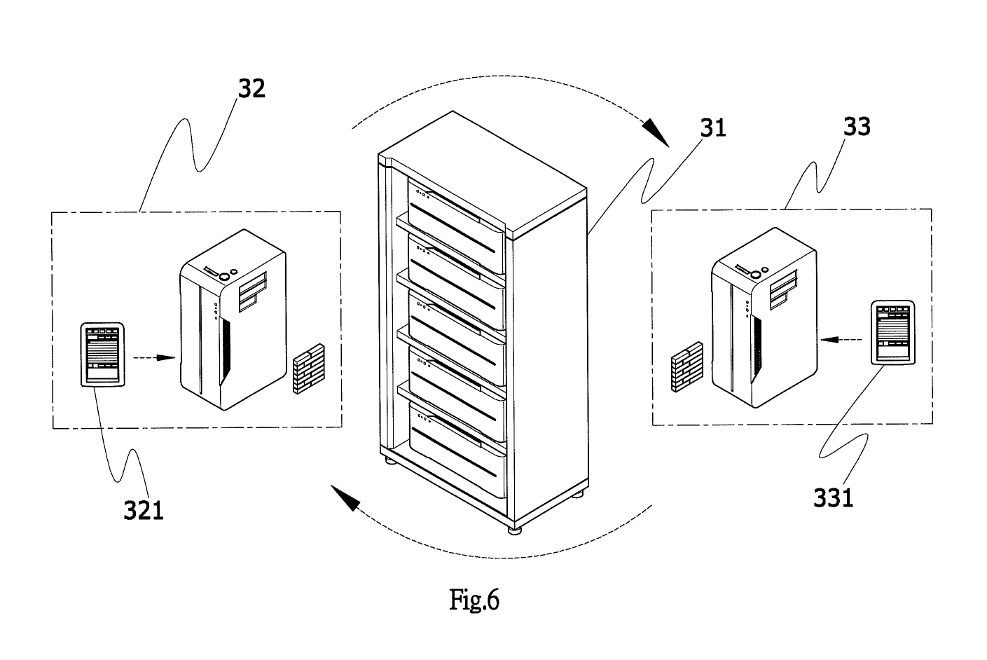

In Step 46, direct network interconnection is established. Referring to FIG. 6 in combination, FIG. 6 is a schematic view (2) of implementation according to the present invention. In FIG. 6, after the calling end 32 and the called end 33 receive the expected network connection port data (D1, D2) from each other respectively, real-time network connection is established. At this time, the network connection between the calling end 32 and the called end 33 does not need intermediary processing through the proxy server 31. The related network connection is simply established by using the multi-terminal network connection systems (321, 331) of the two user ends.

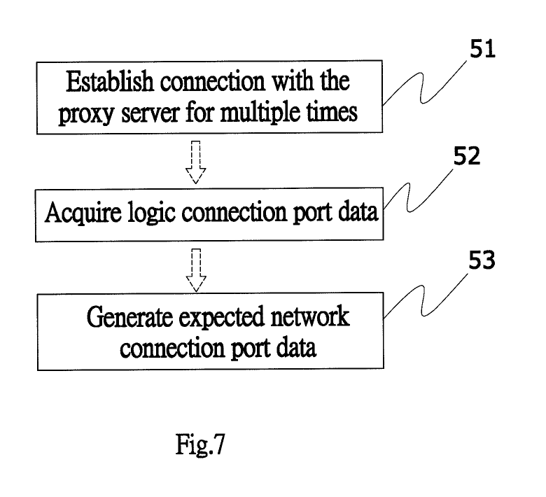

FIG. 7 is a flow chart of implementation of a checking mechanism. In the previous network connection, when the information device of the user end intends to establish network connection, an internal network connection port is configured, and an external network connection port is configured through the firewall or the NAT, so that connection with an external network is realized. However, the user end is unable to acquire its own network connection port to the outside. Therefore, the NAT Internet protocol checking mechanism in the present invention is cyclic encoding or becomes cyclic encoding through setting mainly by using a network connection port of a firewall or a NAT of an existing operating system. As such, after authentication is passed, the user end can acquire data of its own network connection port to the outside and further transfer the data to a third party, thus establishing connection with the third party. As shown in FIG. 7 in combination with FIG. 5, when the called end 33 agrees to establish the connection, the calling end 32 and the called end 33 start the checking mechanism according to the present invention, respectively. Here, only taking the calling end 32 as an example, the implementation mode of the called end 33 is the same as that of the calling end 32. In addition, the implementation process of the NAT Internet protocol checking mechanism is as follows.

In Step 51, connection with the proxy server is established for multiple times. After receiving a message of agreeing on the connection, the calling end 32 establishes connection with the proxy server 31 for multiple times, and the proxy server 31 returns external connection port data D3 to the calling end 32 for each connection.

In Step 52, logic connection port data is acquired. After receiving the external connection port data D3 for multiple times, the calling end 32 checks the external connection port data D3 by using the internet multi-terminal connection system 321, and obtains the logic connection port data after checking.

In Step 53, expected network connection port data is generated. As discussed in Step 52, after the logic connection port data is generated, the multi-terminal network connection system 321 of the calling end 32 further utilizes the data to generate expected external network connection port data D1, so that the calling end 32 transfers the data to the called end 33 to establish direct network connection.

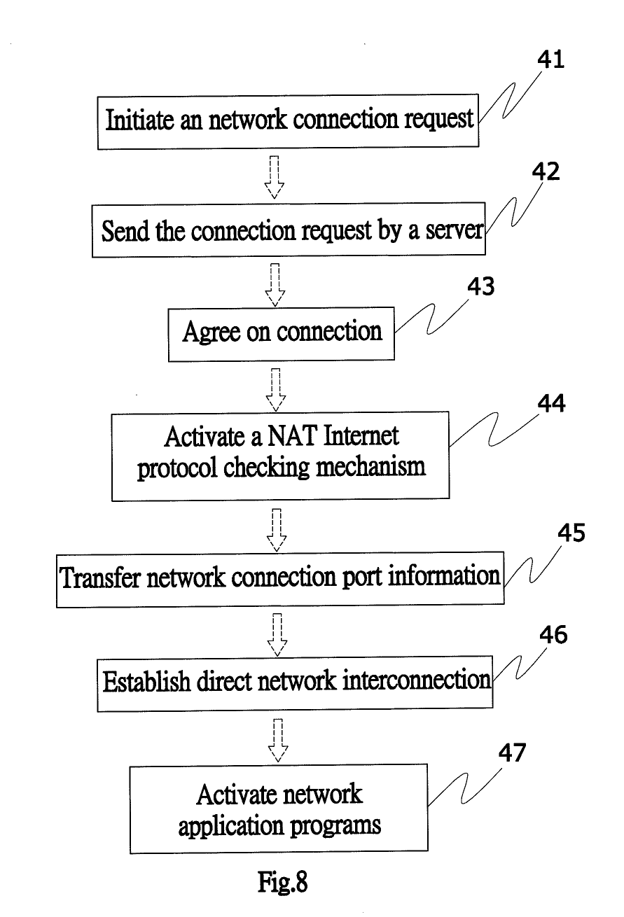

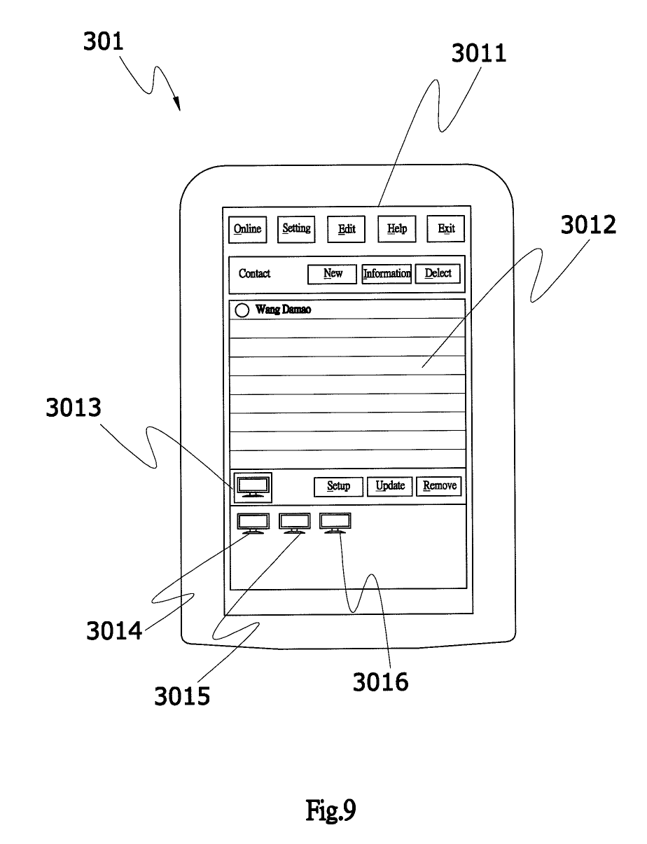

FIG. 8 shows a preferred embodiment according to the present invention. As discussed in Step 46 of FIG. 4, after real-time network connection is established between the calling end 32 and the called end 33, Step 47 (network application programs are activated) in FIG. 8 can be further used in combination. In Step 47 (network application programs are activated) as shown in FIG. 8, after real-time network connection is established between the calling end 32 and the called end 33, various types of network application programs, such as VoIP and real-time communication, can be further loaded in the multi-terminal network connection systems (301, 321, and 331) according to the present invention based on demands of an individual or enterprise. FIG. 9 is a diagram of an interface of a connection system according to a preferred embodiment of the present invention. As shown in FIG. 9, the multi-terminal network connection system 301 of the present invention is installed on the information device at the user end, and has a menu-type user interface 3011. A plurality of menus is configured on the user interface 3011. For example, in a contact menu 3012, information of related network connection ports of colleagues or friends can be recorded in the contact menu through setting. Also, for example, in a network application program functional menu 3013, when the user loads any network application program in the multi-terminal network connection system 301, the network application program loaded by the user is displayed. In FIG. 9, the multi-terminal network connection system 301 is loaded with network application programs such as real-time chatting 3014, remote control 3015, and video conference 3016, the implementation modes of which are as follows. Taking the remote control as an example, referring to FIGS. 3 and 8 in combination, when the network connection is established, both the user ends (32, 33) need to establish the multi-terminal network connection systems (321, 331) according to the present invention, and at the same time, the remote control 3015 needs to be loaded in the multi-terminal network connection systems (321, 331). When the called end 33 receives a connection request from the calling end 32 and confirms the connection, direct connection can be established. Moreover, the remote control 3015 can be adopted to manipulate the information device at the called end 33. The specific implementation is as described above, the details of which will not be given herein gain.

In view of the above, the method of multi-terminal connection traversing the NAT without third party interfacing according to the present invention is applicable to existing network communication protocols. A multi-terminal network connection system is established at each user end to enable the user end to perform related settings or load related network application programs for the network connection. Moreover, during the establishment of the network connection, actions such as data redirection through the proxy server are not needed, and the communication connection ports are checked for the calling end and the called end by using the multi-terminal network connection systems, so as to establish real-time network connection, so that information security vulnerability caused by turning off the firewall or changing the settings of the NAT for the network connection between the user end and the third party is avoided, thereby enhancing the information security of the network. Thus, after the present invention is implemented accordingly, the method of multi-terminal network connection is truly provided, in which the proxy server is not needed, the firewall and the NAT can be traversed, and the related network application programs can be further adopted.

The above descriptions are merely preferred embodiments of the present invention, but are not intended to limit the present invention. Any modification, equivalent replacement, or improvement made by persons skilled in the art without departing from the spirit and scope of the present invention shall fall within the appended claims of the present invention.

What is claimed is:

1. A method of multi-terminal connection traversing a network address translator (NAT) without third party interfacing, applicable to existing network communication protocols, wherein a multi-terminal network connection system is established on an information device of a user end, the method comprising:
initiating a network connection request, wherein a calling end sends a request signal to a proxy server through the multi-terminal network connection system;
sending, by the proxy server, the connection request, wherein the proxy server receives the connection request from the calling end and transfers the message to a called end;
agreeing on connection, wherein the called end agrees on the connection in response to the connection request transferred by the proxy server within a specific period of time, and the proxy server returns related information to the calling end;
activating a NAT Internet protocol checking mechanism, wherein the calling end and the called end check encoding principles of network connection ports through the multi-terminal network connection systems thereof, and generate expected network connection port data, respectively;
transferring network connection port information, wherein the calling end and the called end check the encoding principles of the network connection ports, and transfer the generated expected network connection port data to each other through the proxy server, respectively; and
establishing direct network interconnection, wherein after the calling end and the called end receive the expected network connection port data from each other respectively, direct network connection is established through the network multi-terminal connection system.

2. The method of multi-terminal connection traversing the NAT without third party interfacing according to claim 1, wherein the step of activating the NAT Internet protocol checking mechanism comprises:
performing connection with the proxy server for multiple times, wherein after the user end receives a message of agreeing on the connection, network connection with the proxy server is performed for multiple times, and the proxy server returns external connection port data to the user end for each connection;
acquiring logic communication port data, wherein the Internet multi-terminal connection system of the user end checks a plurality of external network connection port data and further generates the logic network connection port data; and
generating expected network connection port data, wherein the multi-terminal network connection system generates the expected external network connection port data through the logic network connection port data and transfers the expected external network connection port data to other user ends, so as to establish direct network connection.

3. The method of multi-terminal connection traversing the NAT without third party interfacing according to claim 1, wherein after the step of establishing the direct network interconnection, the method further comprises activating network application programs.

4. The method of multi-terminal connection traversing the NAT without third party interfacing according to claim 1, wherein the multi-terminal network connection system further has a user interface.

5. The method of multi-terminal connection traversing the NAT without third party interfacing according to claim 4, wherein the user interface is established with more than one functional menu.
